(19) United States
(12) Patent Application Publication
(10) Pub. No.: US 2026/0050694 A1
(43) Pub. Date: Feb. 19, 2026

(54) SYSTEMS AND METHODS FOR FACILITATING BLOCKCHAIN APPLICATIONS

(71) Applicants: Robert KORNACKI, Road Town (PL); Nicolas ARQUEROS, Road Town (VG)

(72) Inventors: Robert KORNACKI, Road Town (PL); Nicolas ARQUEROS, Road Town (VG)

(21) Appl. No.: 19/101,814

(22) PCT Filed: Aug. 17, 2022
(86) PCT No.: PCT/US2022/040662

§ 371 Date: Feb. 6, 2025

(51) Int. Cl. G06F 21/64; H04L 9/00

(52) U.S. Cl. CPC G06F 21/64; H04L 9/50; H04L 2209/56

(57) ABSTRACT

A method for facilitating blockchain applications may include providing access to a scalability engine for at least one application that is implemented on a blockchain and facilitating execution of the application using the scalability engine. The scalability engine may use a smart contract on-chain that acts as a coordinator with an off-chain state machine that computes a state of the application. Various other methods, systems, and computer readable media are also disclosed.

### BACKGROUND

This application relates to blockchain application technology. Applications such as gaming applications may operate in connection or coordination with a blockchain. Nevertheless, related systems may involve various deficiencies or suboptimizations.

As one illustrative example, related systems may prefer the convenience of centralized methodologies over decentralized methodologies. These related systems may rely on last-generation blockchain technology strapped onto centralized Web2 gaming stacks. Rather than innovating, these projects only use the blockchain as a ledger for tokens (e.g., NFTs), but the entire gaming application itself is run on centralized private servers. In these related systems, the corresponding development team inevitably becomes a centralization point that is forced upon the users in perpetuity, all because their technological stacks never allow them to become truly decentralized. This example problem, as well as related problems, and corresponding solutions, are described in more detail below.

### SUMMARY

In some examples, a method for facilitating blockchain applications may include providing access to a scalability engine for at least one application that is implemented on a blockchain and facilitating execution of the application using the scalability engine. The scalability engine may use a smart contract on-chain that acts as a coordinator with an off-chain state machine that computes a state of the application.

In some examples, the application comprises a blockchain gaming application.

In some examples, the off-chain state machine computes a state of the blockchain gaming application.

In some examples, the scalability engine enables a user with access to the blockchain to read on-chain data that verifies a latest state of the blockchain gaming application in a zero trust configuration.

In some examples, the blockchain preserves substantially all data for operation of the blockchain gaming application.

In some examples, the blockchain gaming application implements passive time such that the blockchain gaming application advances while bypassing a requirement for a user to submit a new transaction to the blockchain.

In some examples, the state machine operates as an L2 chain.

In some examples, the scalability engine computes gas usage based on a calculation in terms of a user address, a game input, and a digital signature of the game input.

In some examples, the scalability engine renders gas usage and transaction fees strictly dependent on a number of bytes that a user submits for their input to the application.

In some examples, the scalability engine enables true blockchain player-versus-environment gaming.

In further examples, a corresponding computer-readable medium may include instructions that, when executed by a physical processor of a computing device, cause the computing device to execute a method including providing access to a scalability engine for at least one application that is implemented on a blockchain and facilitating execution of the application using the scalability engine. The scalability engine may use a smart contract on-chain that acts as a coordinator with an off-chain state machine that computes a state of the application.

In further examples, the corresponding system may include a providing module, stored in memory, that provides access to a scalability engine for at least one application that is implemented on a blockchain and a facilitating module, stored in memory, that facilitates execution of the application using the scalability engine, as well as at least one physical processor configured to execute the providing module and the facilitating module. The scalability engine may use a smart contract on-chain that acts as a coordinator with an off-chain state machine that computes a state of the application.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for facilitating blockchain applications.

FIG. 2 is a flow diagram of an example method for facilitating blockchain applications.

FIG. 3 is a flow diagram of another example method for facilitating blockchain applications.

FIG. 4 is a flow diagram of another example method for facilitating blockchain applications.

FIG. 5 is a block diagram of a scalability engine architecture.

FIGS. 6-10 show examples of code and corresponding data relating to example methods for facilitating blockchain applications.

FIG. 11 is a block diagram comparing related gaming non-fungible tokens with stateful non-fungible tokens.

FIG. 12 is a block diagram of an example computing system capable of implementing one or more of the embodiments described and/or illustrated herein.

FIG. 13 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

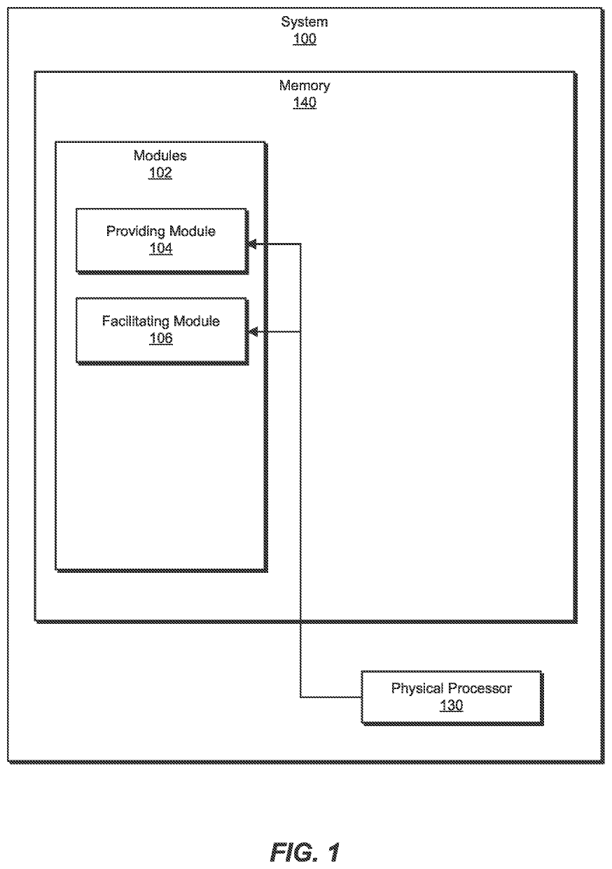

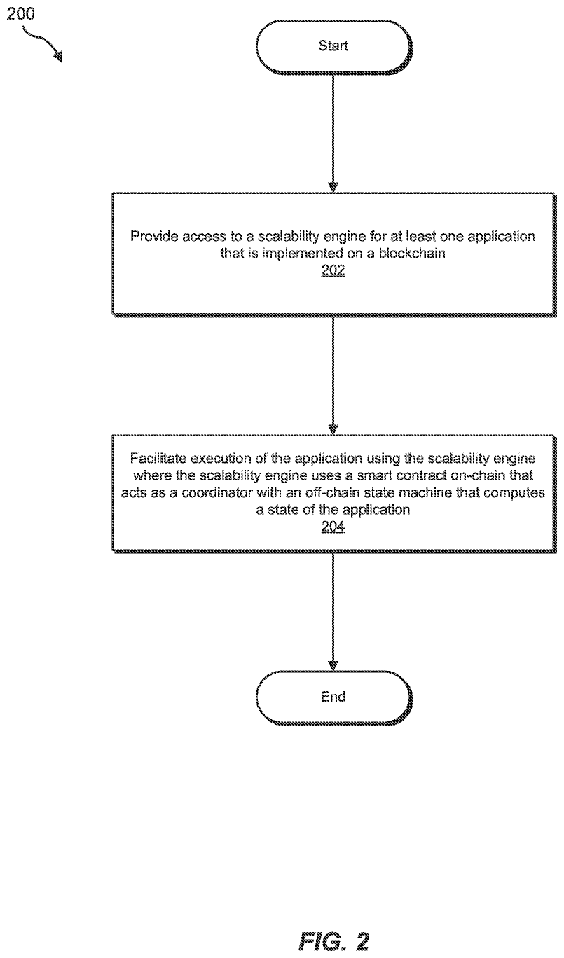

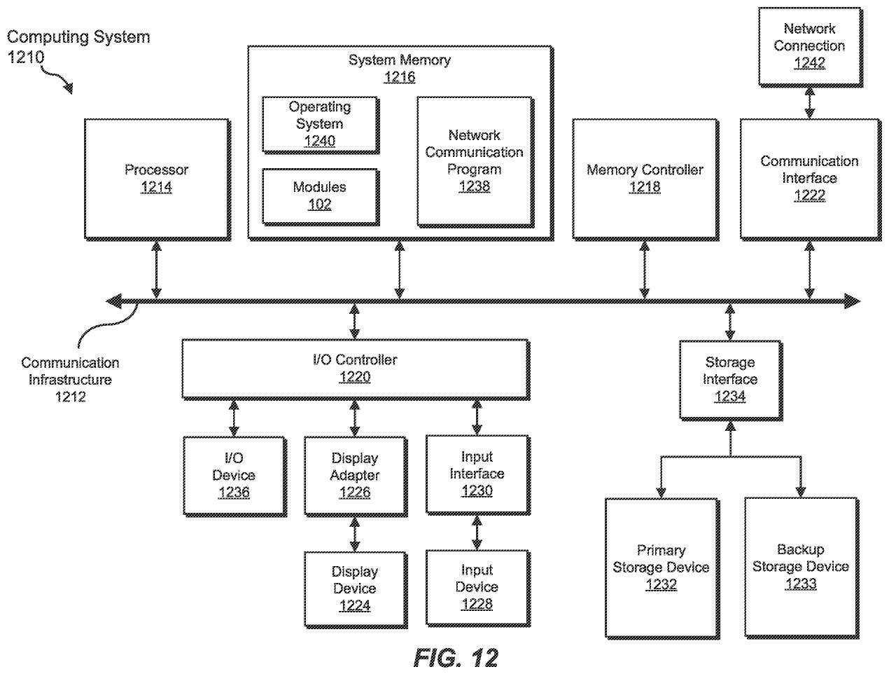

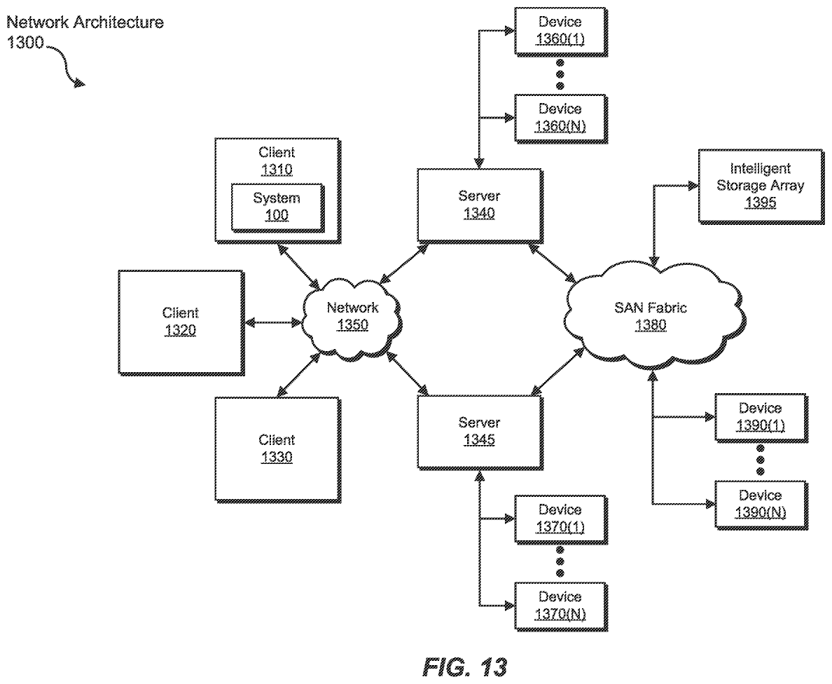

The present disclosure is generally directed to systems and methods for facilitating blockchain applications. The following will provide, with reference to FIG. 1, detailed descriptions of an example system for facilitating blockchain applications. Detailed descriptions of computer-implemented methods will also be provided in connection with FIGS. 2-4. In addition, detailed descriptions of an example computing system and network architecture capable of implementing one or more of the embodiments described herein will be provided in connection with FIGS. 12 and 13, respectively.

FIG. 1 is a block diagram of example system 100 for protecting users. As illustrated in this figure, example system 100 may include one or more modules 102 for performing one or more tasks. For example, and as will be explained in greater detail below, example system 100 may include a providing module 104 that provides access to a scalability engine for at least one application that is implemented on a blockchain. System 100 may also include a facilitating module 106 that facilitates execution of the application using the scalability engine. In some examples the scalability engine uses a smart contract on-chain that acts as a coordinator with an off-chain state machine that computes a state of the application. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices. One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate facilitating blockchain applications. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

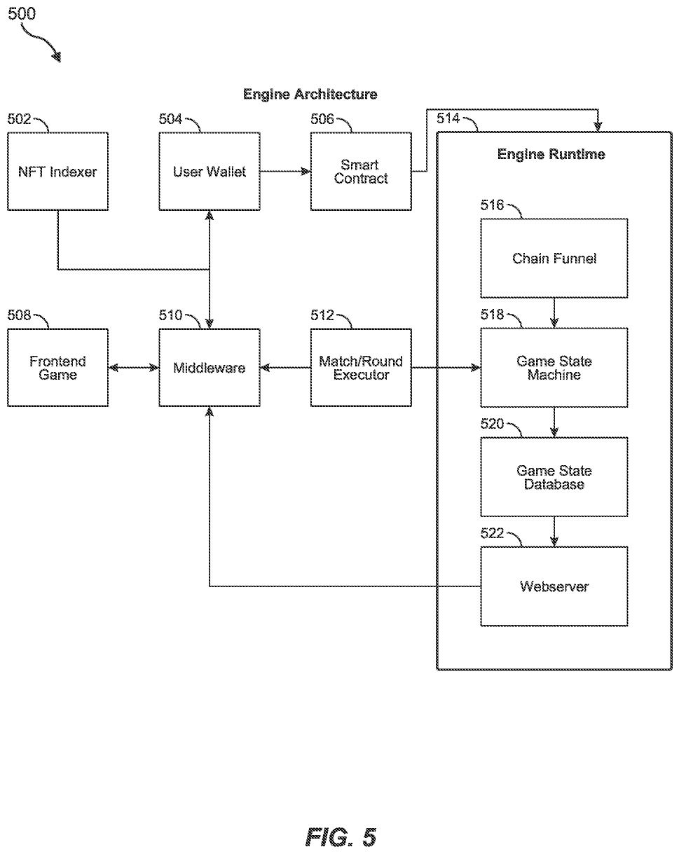

Example system 100 in FIG. 1 may be implemented in a variety of ways. For example, all or a portion of example system 100 may represent portions of example engine architecture 500 in FIG. 5, as discussed further below. More generally, system 100 may be implemented through an end-user computing device (e.g., a gaming computing endpoint, which may correspond to a frontend game 508 in FIG. 5) coordinating with a server (e.g., one or more servers facilitating blockchain transactions, such as middleware 510 or webserver 522 in FIG. 5), where the computing device and the server communicate over a network. The computing device may generally represent any type or form of computing device capable of reading computer-executable instructions. In some examples, the computing device may correspond to any computing device. Additional examples of the computing device include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

The server may generally represent any type or form of computing device that is capable of facilitating the performance of one or more example methods described herein. Additional examples of such servers may include, without limitation, security servers, application servers, web servers, storage servers, and/or database servers configured to run certain software applications and/or provide various security, web, storage, and/or database services.

The computing device and the server make communicate over a network, and this network generally represents any medium or architecture capable of facilitating communication or data transfer. In one example, the network may facilitate communication or data transfer using wireless and/or wired connections. Examples of the network include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

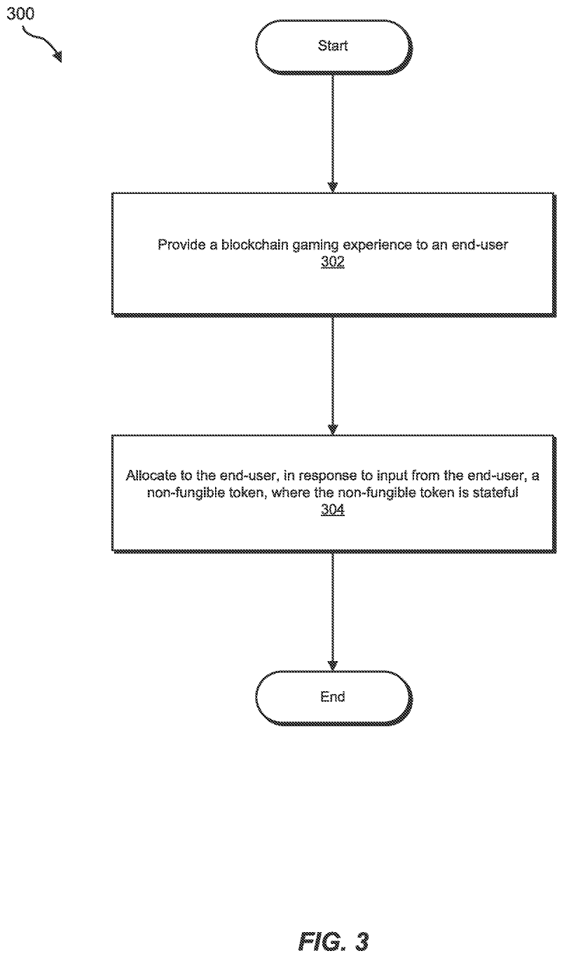

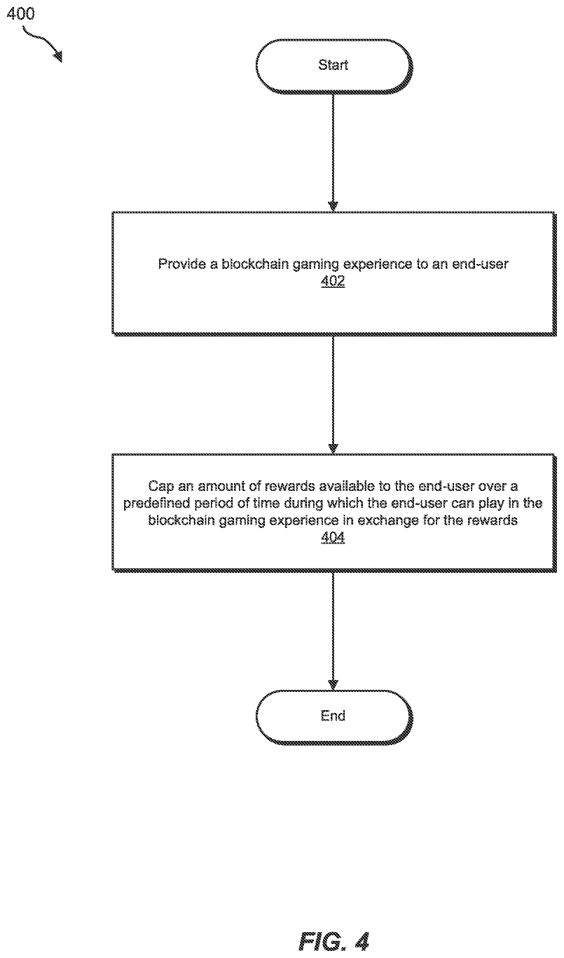

FIGS. 2-4 are flow diagrams of example computer-implemented methods for facilitating blockchain applications. The steps shown in FIGS. 2-4 may be performed by any suitable computer-executable code and/or computing system, including system 100 in FIG. 1, engine architecture 500 in FIG. 5, and/or variations or combinations of one or more of the same. In one example, each of the steps shown in FIGS. 2-4 may represent an algorithm whose structure includes and/or is represented by multiple sub-steps, examples of which will be provided in greater detail below. Moreover, although not expressly depicted in the figures, the methods of FIGS. 3-4 can be implemented through modules in a manner parallel to the implementation of the method of FIG. 2 through modules 102 (i.e., through respective pairs of modules implementing respective steps of the corresponding methods).

Beginning with FIG. 2, at step 202 of a method 200, one or more of the systems described herein may provide access to a scalability engine for at least one application that is implemented on a blockchain. Similarly, at step 204 one or more of the systems described herein may facilitate execution of the application using the scalability engine. In these examples of method 200, the scalability engine may use a smart contract on-chain that acts as a coordinator with an off-chain state machine that computes a state of the application.

As used herein, the term “scalability engine” or scalability solution refers to a software-implemented engine, solution, or framework that interfaces or coordinates with a blockchain such that a transaction or processing speed, bandwidth, number, frequency, or other scalability-related metric is improved. In other words, as understood by those having skill, the scalability engine may address or improve scaling problems, which occur when the amount of data being processed by the blockchain reaches a constraint or maximum because of a lack of capability or resources associated with the blockchain. The example methods of this application may be implemented as Layer 2 scalability engines, and may be implemented as rollup-adjacent technology rather than as classical rollups, as those terms are understood by those having skill in the art, and as discussed further below in more detail in connection with FIGS. 5-11.

In various examples, the engine of this application uses rollup-adjacent research (state machines, such as GA state machines), thereby bringing scalable trustless blockchain gaming to the world. This means that any games built with these example engine implementations inherit the same scaling properties as rollups, with the addition of further new scaling optimizations aimed for the gaming use case (parallelism, input compression, and more). Even though, in some examples, games built with one or more disclosed implementations of the engine of this application are not necessarily rollups per say (but a new type of state machine which lives or operates as an L2), they nonetheless can take advantage of rollup technology features such as validiums or data availability chains, thus staying competitive over the long term.

In various example implementations, the engine of this application offers orders of magnitude better on-chain scaling without adding new points of centralization to the system. Various implementations of the engine can achieve up to 98,500% on-chain gas usage reduction compared to representative newly released on-chain games. In contrast, if such games were built using one or more example implementations of the engine, they would have a near constant gas usage no matter how much complexity was introduced to the game logic. Instead, such representative games of the related art will feature an exponential curve where users keep paying more and more.

Because various implementations of the engine are based off of rollup-adjacent research, it can take advantage of on-chain security with 100% off-chain game logic. Furthermore, various implementations of the engine offer a greater level of flexibility over current generation rollup technology, wherein centralization concerns are lowered due to the fact that batchers/sequencers are not required. The technology can already achieve 10,900% gains in efficiency, for example, in comparison to related art games.

To understand how example implementations of the engine can be so effective, it is helpful to consider a couple of equations and break the advantages down step-by-step. In a first equation, “g=i*12+24,349”, the reader can see that gas usage is reliant on i, which is the number of bytes that the user has submitted for their input to the game. This means that unlike on-chain games, no matter how many loops the code performs, how long it takes to execute, how much global game state is being mutated or created, nor any other performance-related factor, the gas usage (and thus transaction fees) for the user are strictly dependent on how much data the user submitted as input.

Although related systems might seek to optimize on input size, these example implementations of the engine unlock every other scaling axis for free by strictly making gas usage dependent on i. In addition to these significant benefits, there are two other values as part of the equation. 12 is unfortunately a static cost scaled by the size of the input data which cannot necessarily be decreased, however 24,349 is the base amount which users must pay when they issue a transaction with game input by themselves.

Thus, by introducing the concept of batching (putting many user submitted game inputs in the same transaction), the technology can average out this fixed cost across all of the users. This is what the second equation achieves, “g=((40+i+s)*n*12+24,349)/n”. Each user may provide their address (40), their game input (i), and a signature of their input(s) which was created using the private key corresponding to the address. This means that though the number of bytes each user is required to provide is in fact greater, this increase in base size is greatly net positive as it is counterbalanced by the 24,349 savings. Games built with one or more implementations of the engine that can take advantage of both users submitting their own game input, or having the optionality of choosing dispatch solution to enjoy cost (and potentially UX) savings and improvements.

Lastly, with batching in place it also becomes quite realistic to look at custom-built compression protocols which decrease the size of i even further across all users in a batch. A lot of data is likely to be repeated in a batch with hundreds or thousands of user inputs for the same game, and as such compression algorithms and input reduction mechanisms can be developed to optimize this further.

The fact that these example implementations of the engine can be built on rollup-adjacent research and manage to offer such great scaling benefits brings up the topic of comparing classical rollups with rollup-adjacent innovations from scratch. Since some blockchain games have opted to implement their game logic on-chain, the question arises whether these games could be ported to a rollup and acquire the same benefits as these example implementations of the engine. Although this might sound possible in theory, it results in a long list of problems.

Regarding storage problems, rollup-based games are at a significant disadvantage. On one end they are severely limited by the constraints of the Ethereum Virtual Machine (EVM), wherein they cannot easily store large chunks of data. The EVM only allows data to be stored in 32 byte slots, and the default gas consumption of the EVM highly discourages saving large amounts of data. It is possible to fork the EVM to tweak and optimize to address this, however these are breaking changes which destroy native EVM compatibility and as such will require a custom implementation (thus losing access to using all current EVM contracts on the rollup).

On the other end, using the EVM means that related games do not have access to world-class relational databases (such as MySQL, PostgreSQL, etc.). Instead game developers are left with a very clunky low-level interface for accessing stored data with 1/100th the querying power compared to these battle-tested databases used by millions of projects every day. This translates into much more complicated and bug-prone code, slower development times, and a much worse developer experience.

Second, the EVM also has very aggressive restrictions in regard to its runtime and the available memory. Because the EVM is gas-conscious, every time the game developer uses more RAM, more gas is used in the EVM. Rough estimates of the EVM with default parameters put the maximum amount of available memory in a single block to be approximately 2.5 gb (using 100% of the gas of the block, meaning nothing else can be done). This is a very limited amount, and would have a hefty price tag attached to it in the form of transaction fees.

However, the memory complications are not in fact the worst part from a game development perspective. The EVM is stack based with a maximum depth of 1024, with each unit being 32 bytes, and a maximum stack query depth of 16. This has numerous implications all across the design of a game smart contract, including for example that only up to 16 local variables can be accessed at one time. In palpable terms this means that the complexity of managing data, especially for large computations, is incredibly high.

Game developers stuck on the EVM are hobbled by using essentially outdated technology, comparable to trying to fit games on floppy disks, which run on computers with limited computation and memory capacity, while being forced to use a very low-level language (e.g., Solidity). Unfortunately, even though they have to deal with such low-level matters, developers are not able to take advantage of any performance benefits that true systems languages like Rust or C++ offer.

In various examples, the engine of this application on the other hand allows developers to use whatever language they prefer best for the core game logic, thus allowing the developers to use their libraries/frameworks/stacks they are already familiar with, along with significant performance improvements.

Third, on the topic of performance, games on rollups are bound to all of the EVM's design decisions. Chief of which is the fact that the EVM is a purely sequential computing virtual machine, which has no concept of parallelism at all. Every transaction submitted to the rollup thus must be executed in order one-by-one. Though this execution happens off-chain, and although developers might simply use a stronger CPU to try to patch over this problem, at scale this manifests as an upper ceiling of how advanced the games can become.

In some examples, an innovation of the engine from an end-user perspective is the addition of passive time. This innovation generally has sweeping effects which improve scalability and unlock unlocking new game models that were never possible before on the blockchain.

With smart contract powered protocols, on-chain state is only ever mutated when transactions are added into blocks. In the gaming context, this means that the game never updates unless some user submits a transaction to trigger a smart contract. This means that these blockchain games have no concept of passive time, and this prevents many core features from being possible.

In various example implementations, the engine of this application on the other hand allows passive time to progress without a single transaction being issued, thereby providing game developers and users one or more of the following example benefits:
Unlock true blockchain PvE (Player Vs. Environment) gaming, where the player must deal with non-human AI which actively makes moves/attacks as time passes automatically
Provide the ability for blockchain PvP (Player Vs. Player) games to implement random map events and/or AI elements which effect the match state automatically, and thus offering dynamic and unpredictable gameplay
Enable games where users set wide sweeping (macro) strategies, wherein units continue to perform their tasks automatically every single block (e.g., fetch resources)
Allow users to lock in game moves which will automatically take place in the future (strategic focused games)
Support a passive-class of games where users may only make one or two moves a day, but the state of the map/match/game continuously changes every few seconds
Provide games the opportunity to implement day/night cycles

Moreover, in some example implementations, the engine of this application enables passive time to be provided in games without charging users a single extra penny, thus saving players potentially thousands of dollars in transaction fees over the long-term thereby drastically improving the gaming experience.

In addition to all of the previously described benefits that can be provided by various example implementations of the engine, in comparison to using EVM rollups, the following list rounds out further example benefits that are achieved in various embodiments:
Cheaper transaction fees due to the fact that game input can be better compressed, no state root is required on-chain, no intermediary EVM boilerplate is needed, and no optimistic or zero knowledge primitives are required.
No risk of rollbacks due to bad actors submitting invalid state transitions like in optimistic rollups (which would revert everyone's game state, and require rollback checking to be implemented in every game incurring high complexity cost with worse UX).
Unlock oracle-free advanced randomness generation which takes advantage of underlying blockchain's leader selection security.
Enabling stateful NFTs (as discussed in more detail below). For a rollup EVM, stateful NFTs would require forking the EVM and redesigning how the rollup interacts with the L1 (because a rollup with EVM does not reference the L1 for who has the right to edit the rollup EVM smart contract state).
Freedom to use any programming language to develop games, enabling taking advantage of existing programming ecosystems and getting around EVM limitations. Strictly relying on batchers (as rollups do) results in higher average latency, and which may prevent certain game styles from being enjoyable/playable. In various examples, the engine comes out ahead allowing direct user input submission without complex game theory.
In various examples, the engine can run on top of rollups and maintain all of their respective benefits.

In various examples, the engine enables games to rely on the underlying blockchain for decentralization and security, yet have the freedom to scale and offer novel functionality on top. In contrast, related blockchain gaming systems do not achieve these benefits. As further discussed above, these related systems generally selected centralized approach solutions due to the short-term convenience that these approaches provide. In other words, corresponding developers for these related solutions relied on last-generation blockchain technology strapped onto centralized Web2 gaming stacks. Rather than innovating, related systems only use the blockchain as a ledger for tokens such as NFTs, but the entire game itself is run on centralized private servers. The development company corresponding to such a related system inevitably becomes a centralization point that is forced upon the users in perpetuity, all because their technological stacks never allow them to become truly decentralized.

FIG. 3 shows another example method 300 for facilitating blockchain applications. Example method 300 may relate in particular to stateful non-fungible tokens. At step 302, one or more of the systems described herein may provide a blockchain gaming experience to an end-user. The blockchain gaming experience may be provided through an example implementation of the the engine, for example, and as further discussed above. Similarly, at step 304, one or more of the systems described herein may allocate to the end-user, in response to input from the end-user, a non-fungible token. Notably, as discussed at length below, the non-fungible token may have the property of being stateful, which may refer to these tokens recording dynamic transitions in state (e.g., game state), as distinguished from traditional or classical NFTs.

Classical NFTs within related blockchain gaming environments are just barebones ERC-721 (or ERC-1155) tokens with no dynamic state attached to them. In other words, a user can buy an NFT that represents something like an in-game unit, but that NFT will always and forever only represent that static unit. The unit attached to that NFT can never accrue experience, level up, gain items, have new armor attached to it, or do anything that actually mutates the state of the unit itself. At best related systems might burn the old NFT and create a new NFT representing an upgraded version of the initial unit. This kind of solution is an ill-fitted band-aid over a major problem that limits the capabilities of these NFTs in games.

The process to upgrade NFTs by burning is very cumbersome for the end user, has high gas fees due to executing smart contracts on-chain, and is a very brittle mechanism with limited usability. The games themselves cannot be designed with much complexity in this area as the number of smart contract calls and the extensive NFT burning/minting graphs/paths suddenly expand by multiple orders of magnitude into an unwieldy and expensive complication.

In contrast to these classical non-fungible tokens, the technology of this application can leverage one or more of the various novel innovations in different embodiments of the engine to build a whole new class of tokens: stateful NFTs. Based on research into state machines, such as GA state machines, which are at the root of various examples of the engine, it becomes possible to create and provide non-fungible tokens that are stateful, and which have dynamic in-game state information encoded within these non-fungible tokens. This breakthrough can effectively transform NFTs from merely being a boring/dead token which forever represents the same asset into a live asset that continuously accrues varying/dynamic attributes (e.g., levels/stats/equipment, etc.) and more over time. Moreover, all of these dynamic attributes can potentially transfer over from one player to another when the NFT is sold on the open market, and yet there is no extra information held on-chain, which further means that the NFT is 100% composable with all of the current NFT infrastructure in the EVM ecosystem.

An analogy helps to explain the relevance of stateful non-fungible tokens. This innovation is analogous to when Nintendo added save batteries to handheld game cartridges for the Game Boy. Before save batteries the games were still fun and exciting, but users had to keep replaying the same levels and everything felt very static and cumbersome. While gamers did not know what they were missing at the time, when they began playing games with save batteries, such as the original Pokémon games, it become extremely clear to end-users what they were missing out on. The addition of the save battery, and thus being able to maintain game state, opened up horizons previously unimagined. With users able to save the Pokémon that they caught and keep leveling them up, this meant that they accrued perpetual value to the player over time. Nintendo understood this and capitalized on it with the ability to trade Pokémon to others via a Game Link Cable. This brought on a brand new realm to gaming as a whole, moving it away from arcade-style temporal games, to now allowing the user to have valuable and persistent game state that they owned and could pass on to others. stateful NFTs of FIG. 3 are in fact a parallel innovation in this regard. The stateful NFT maintains persistent game state, while the underlying blockchain technology acts, by analogy, as the Game Link Cable which enables users to trade their stateful NFTs.

One helpful embodiment of the stateful NFTs corresponds to embodiments whereby the stateful NFTs function as end-user accounts, as further discussed below. In a future of real decentralized gaming, it can be desirable for users to be able to accrue state over time. In classical online gaming, this is done with accounts, however this model typically relies on centralized servers. Related blockchain gaming solutions attempt to limit as much perpetual game state as possible, and whatever they do save is always attached to a wallet address.

Wallet addresses however are sub-par for the job. They are not tradable, which undermines away all the benefits of having the game attached to a decentralized ledger in the first place. Furthermore if users ever upgrade, switch wallets (i.e., hardware wallets), or end up in a situation where the private key is compromised, they have no path for redress.

In contrast, stateful NFTs functioning as accounts address and solve the problems outlined above. Account stateful NFTs enable each user to retain state for each game they play in a blockchain gaming environment. Said differently, each of these NFTs effectively acts as an “online account” which allows users to save their wins/losses, their in-game items, and their stats in games. Accordingly, in various example implementations, to take part in such a gaming experience in full, a user may be requested or required to obtain an account NFT.

Unlike in related blockchain gaming projects which optimize for short term profit via their NFTs, account NFTs can be a core part of at least one embodiment of this technology. For this reason, account NFTs in these examples may be accessible to end-users at reasonable prices. As one illustrative example, account NFTs may be priced at a smaller price point (e.g., $10) in stablecoins that feature no fluctuations due to demand. In this embodiment, such a pricing scheme would encourage more and more users to enter into the gaming environment, rather than letting the early users take advantage of future users, as further discussed above. Just like how users build up accounts in online games with levels/items/publicly visible stats, all of this data can, in some examples, be attached to account NFTs. Users can optionally sell their account NFTs to others, and the buyer in that scenario may have access to everything the previous owner had. By analogy, this acts just like an account transfer from user A to user B, but is performed through the account NFT rather than a traditional user account.

This type of account trading was heavily discouraged in the world of MMOs, with the label of “real world trading” being a bannable offense. Nevertheless, these efforts did not stop black markets from popping up and still taking advantage of the demand.

In some implementations of method 300, however, account NFT trading can be decidedly inserted into the system as a core mechanism. Users who spend time building NFTs can thereby sell on the open market to others. Because EVM-based blockchains are public, everyone in the world knows when an account NFT has moved from user A to user B. Accordingly, it is unlikely that anyone would be willing to take the risk of selling private keys to each other (because there is no security once the private key is shared), and as such account NFT transfers have advantages, in some examples, as a primary option for performing trading. Consequently, account NFTs provide the benefits of new users who want to quickly find equally willing sellers, together with the benefits of having all such trades being recorded visibly on-chain. Moreover, account NFTs may in some examples enable other protocols on top to be implemented which filter/disallow that specific fraction of account NFTs that have been moved between wallets in the last X days, thus addressing all of the issues which were entailed with the corresponding model in Web2.

Within an example of the blockchain gaming environment outlined above, users may inevitably start to desire to convert their favorite classical NFTs into account NFTs. In some examples this may enable such players to take NFTs which had been purchased on decentralized markets, obtained from another game, or made themselves, and transform them into stateful NFTs, and specifically account NFTs, as further discussed above. Thus, the NFTs may thereby evolve in these examples from just being plain old JPEGs to now having functionality in terms of dynamic state-maintaining NFTs.

Moreover, the option in these examples to convert classical NFTs into stateful NFTs or account NFTs may be monetized through a pricing premium. In contrast, other users may still have the option to create a standard account NFT using the lower fixed price point discussed above. Moreover, the feature of stateful NFTs being tradable can result in a new mechanism for increasing value of existing classical NFTs. In other words, users can take classical NFTs that are already valuable (e.g., CryptoPunk), convert these classical NFTs to stateful or account NFTs, and thereby start accruing additional game state information on top of the information corresponding to the pre-existing classical NFTs. As one arbitrary and illustrative example, a user will no longer just own “CryptoPunk 1859”, as with a classical NFT associated with an illustrative example user account, but “CryptoPunk 1859 which has max level in Game A, some rare cosmetic items in Game B, and is at the top of the leaderboard in Game C”. Each of these extra pieces of dynamic state attached to the NFT increases its value.

In some examples relating to method 300, stateful NFTs can also function as in-game item storage boxes. Going past the account use case of stateful NFTs, the corresponding technology can now utilize the blockchain for what it does best, which is to act as a ledger of ownership.

The vast majority of online games in the Web2 world all have some sort of trading system between users. This might just be the ability to send someone an item, potentially do an active trade, or maybe even have a full-fledged auction house. Typically, this would require implementing these ledger-like pieces of functionality inside the game logic itself. However, this is clearly extremely redundant when games corresponding to method 300 are running on top of an EVM powered ledger, which is orders of magnitude more capable and interoperable than anything engineers could build inside of the game.

As such, stateful NFTs enable the attaching of a limitless amount of in-game state to on-chain NFTs, all without spending a single extra unit of gas or increasing transaction fees. In various examples, stateful NFTs themselves act as a bridge between the game and the ledger, thus bypassing the need for optimistic fraud proofs, zk validity proofs, or any complex bridging mechanism, such as those which rollups classically use.

In view of the above, the stateful NFT technology of this application may in some examples correspond to a storage box NFT. In these examples, the corresponding blockchain gaming environment can create a set of storage box NFTs. Moreover, the storage box NFTs may in some examples be generally interoperable between multiple different ones (e.g., substantially all or all) games within the same blockchain gaming environment. By way of illustrative example, a user can purchase a storage box NFT (or receive it for free, but take a percentage cut on every trade/sale) and then use it with whichever game that they have items/equipment/cosmetics that they want to sell or send to somebody else.

By simply holding the storage box NFT in the corresponding wallet possessed by a particular user, the user has the right to add in-game state information or attributes to it. As such the particular user could fill the storage box NFT with a multitude of different in-game items that are valuable to others, go to a marketplace (e.g., OpenSea), and then sell it to other players who value those in-game items. In these examples, the buyer in such a transaction receives the NFT via the on-chain smart contracts that initiated the sale, and once complete the buyer has complete access to all of the in-game items that were in the Storage Box. Even as new items are released in games within this environment, these new items can be added into storage box NFTs without any on-chain smart contract updates.

FIG. 4 shows another example method 400 for facilitating blockchain applications. In particular, method 400 may correspond to a “play2farm” or “play-to-farm” embodiment, as discussed in greater detail below. For example, at step 402 one or more of the systems described herein may provide a blockchain gaming experience to an end-user. Accordingly, step 402 of method 400 may parallel step 302 of method 300, as further discussed above. Moreover, at step 404, one or more of the systems described herein may cap an amount of rewards available to the end-user over a predefined period of time during which the end-user can play in the blockchain gaming experience in exchange for the rewards.

The technology of this application innovates in the realm of tokenomics by implementing a new model, Play2Farm (P2F), that supersedes the related Play2Earn (P2E) model that some blockchain games use. P2E has major pitfalls that make it unsustainable over the long term.

The base idea behind P2E is that users can keep playing the game to acquire fungible tokens which can then be used to perform some basic actions. A clear example can be found in one representative related game, where breeding new NFTs requires using a corresponding fungible P2E token. Although this may seem like an advantageous system at first, the sustainability of such dynamics clearly has not played out even in the short span of time that this representative related game has been active. The related game has only gotten more and more popular over the last year, yet empirically the price of the P2E token has continued to drop lower and lower. For example, over a period of approximately 11 months, this P2E token experienced approximately a 98.6% drop in token value.

The above example illustration highlights multiple reasons why the P2E model is not actually desirable in practice over the long-term. Various ones of these reasons originate from the fact that, in general, Play2Earn is a model which attempts to “duct-tape” centralized online gaming technology onto newer decentralized technologies. Because P2E attempts to reward actors who play their game, it is inevitably a system where computers, who can play 5000× faster and in 5000× more browser windows than a human ever could, will always take advantage and thereby destroy the sustainability of the tokenomics as a whole. Such computers and their operators may be labeled as “botters,” as understood by those having skill in the art. Any blockchain game which rewards players with tokens for successfully performing actions in their game will always privilege botters with earning the vast majority of token rewards. These botters will always immediately dump the tokens on markets in order to realize and maximize their profit at the cost of long-term project success and sustainability. This leaves the good-acting players who believe in the project to become bag holders who lose out in the end.

The gaming industry, specifically MMOs (massive multiplayer online games), have spent untold billions of dollars over the past two decades trying to eradicate botting. Even with all of this funding, they have proven that no matter how much money is thrown at the problem, solving botting for good is just not possible. Even the leading game development companies in the world today are still playing a constant cat-and-mouse game trying to detect and ban botters.

What this means is that any tokenomic model which is susceptible to botting destroying the economics of the project, such as P2E, can never succeed in the long term. The project must inevitably always stay centralized because the game development company must be in control so that they can try to ban as many botters as possible to temporarily keep the token price from tanking towards zero. Thus blockchain P2E games will never become truly decentralized, the players will never be able to truly own and control the games, and botters will constantly be a menace that drag the projects' valuations lower and lower while damaging the in-game economics for actual players. There is no way to fix this reality, and the only way forward is to start from new foundations and build a tokenomic model that takes the problem seriously. As discussed further below, Play2Farm loosely refers to a cluster of embodiments for a novel tokenomic model disclosed in this application. Based on lessons from the failures of P2E along with useful lessons from the DeFi space, P2F offers users a new generation of blockchain gaming tokenomics.

In P2E, the system seeks to optimize for rewarding users so that they spend their tokens to perform game actions which remove the tokens from the global supply. The hope for long-term sustainability is that users are more excited to spend the tokens they earn on the game itself such that there is more global demand for using the tokens than selling the tokens on the open market. With the reality of botting, this is never achievable because the vast majority of rewarded tokens go to actors who dump them immediately on the market, thereby dragging the price down.

With Play2Farm as described in example embodiments of this application, however, one or more of the following goals can be pursued:
Ensure botters do not have an edge over normal users
Allow users to reuse the same tokens they purchase for different games in the blockchain gaming environment
Optimize for limiting/removing fungible tokens from the global available supply to ensure long-term stability
Reward users with APY for holding fungible tokens and playing games within the blockchain gaming environment
Limit token burning in favor of locking to encourage users to buy more tokens knowing they never lose them

In short, Play2Farm allows players to take part in token farming. Token farming in various examples requests or requires that users stake their tokens with a specific game of their choice. By staking their tokens in farming, they have the ability to earn APY on their tokens (with further tokens as rewards) while also generating such tokens for the treasury of the specific game they have staked with, as discussed in greater detail below.

In some embodiments, in order to realize a particular reward, such as the APY outlined above, the user must play one or more games (e.g., must play the specific game they are staked to), at least X numbers of times within a period of time Y. For example, in a specific embodiment the user may be required to play a specific staked game one time a week in order to earn the APY. Thus, in this specific example, if the user fails to do so, that user will have missed the opportunity to take part in farming for the week, and thus receive no rewards. As such, in P2F users and botters can generally have a completely level playing field, getting around all of the problems of P2E entirely.

The above example focuses on (i) a particular reward (APY), (ii) based on a number of game plays over a period of time, (iii) in a particular game. In other or broader embodiments, however, the general inventive concept may correspond to simply limiting the amount of a particular reward (APY, fungible tokens, NFCs, etc.) that a particular user account may obtain per a particular measurement of game involvement or engagement. In other words, there may be a constraint or Placed on the amount of a particular reward that any user account, botter or human, within a set of user accounts, such as all user accounts, can obtain over a unit of time or a unit of game engagement, because botters and humans generally cannot be distinguished by anti-botting technology. In various examples, the limit may be set to an amount approximately corresponding to a normal or casual amount of game engagement (e.g., playing once a week) for a natural human being in contrast to behavior by botters. Thus, in other examples, different types of rewards may be capped in this manner. The amount of game engagement may also be measured in a variety of different ways, such as a number of times executing/playing the game, a number of minutes or an amount of time playing the game, a number of particular game actions performed (e.g., specific game actions that result in corresponding specific rewards), a measurement of game activity that discounts for idleness as distinct from active or aggressive gameplay, etc. Similarly, the measurement of game engagement can generally be measured across some predefined period of time, and yet this defined period of time may be defined in a variety of different ways, such as a fixed increment schedule (e.g., the user must play the game at least once every week beginning at midnight on Friday), or on a rolling basis (e.g., the user must play the game at least once in the past month), etc. And so on.

In other words, the general idea is to cap or limit the amount of a particular reward, or a particular set of available rewards, such that game engagement beyond a particular threshold associated with normal human play no longer results in additional accumulation of such rewards, whereas game engagement beneath this particular threshold still allows the corresponding user account to accumulate additional such rewards, and thereby both human beings and botters would be on an even playing field (i.e., because it has proven to be impractical for anti-botting technology to distinguish between the two and therefore this application's P2F system caps everyone equally). Moreover, the definition of a statistical threshold beyond which game engagement is no longer considered humanlike, and therefore beyond which the corresponding user account can no longer accumulate additional rewards, can be measured in a variety of ways, including manual inspection, administrator moderation, as well as through supervised or unsupervised machine learning or labeling technologies, as understood by those having skill in the art.

Returning to the more specific examples first introduced above, at any moment users can begin the unstaking process to withdraw their staked tokens, thereby providing them with the freedom to stake with other games in the same system, use their tokens with DeFi protocols, or anything else they so desire.

By taking a look at existing Point-of-Stake and staking protocols in the blockchain space, the reader can see that a very large percentage of the total available token supply can be staked in order to take advantage of P2F. This case is strengthened multiple times over thanks to the optionality of unstaking at any time with no risk of losing tokens for the end user.

In view of the above, the various embodiments of P2F farming disclosed herein address each of the deficiencies that are associated with P2E, while nevertheless leveraging lessons from L1 blockchains and DeFi.

An additional examples, token farming can be used to unlock premium content. In these examples, once the user has staked their tokens with a specific game for farming, they immediately unlock a major new piece of functionality as well. In more particular examples, the users in fact unlock all of the core content (units/weapons/cards/maps/etc.) of the corresponding game.

Innovating at the smart contract level can help address problems associated with Web2 online games. For example, some of these related Web2 online games take payment systems to an extreme with constant micro-payments for unlocking every minute feature. This model has time and time again shown to be a very short-sighted play, wherein the player base begins to resent the development company thereby acquiring a significant reputational hit. Thus the goal is to create an innovative new model which empowers users with exciting capabilities rather than aggressively selling features that should have been included in the first place. Thanks to the fact that a smart contract EVM-powered ledger is provided as part of various example games of this application, as discussed above in the context of the gaming engine, there is a lot of flexibility in what can be implemented.

Returning to the figures, FIG. 5 further discloses an example engine architecture 500. As further shown in this figure, engine architecture 500 may further include an engine runtime component 514, which can further include one or more of a chain funnel 516, a game state machine 518, a game state database 520, and a webserver 522. Engine runtime component 514 can be implemented off-chain, as further discussed above, which can result in the benefit of game logic being processed off-chain as well. Chain funnel 516 can funnel information regarding game state into game state machine 518, for example, which can further record game state information, and/or other metadata relating to game logic or dynamics, within an off-chain state machine. The corresponding state machine can effectively process changes in game state and/or game logic on-chain rather than attempting to record such changes on-chain, which results in all of the cumbersome inefficiencies that are outlined above and associated with related blockchain gaming technologies. In addition to the state machine itself, engine runtime component 514 can further include a game state database 520, which can store additional and/or related, and potentially more detailed, information regarding game state and/or game logic off-chain. Because game state database 520 can be implemented off-chain, developers can benefit from the use of more powerful and robust database technologies and platforms, as further discussed above. Lastly, engine runtime component 514 can further include webserver 522, which can further provide an interface through the web between end-users (e.g., corresponding to frontend game 508), on the one hand, and other components such as middleware 510 and/or webserver 522, as further illustrated in FIG. 5. Middleware 510 can generally provide an interface between front-end game 508 and one or more on-chain or on-chain related components, including NFT indexer 502, user wallet 504, and smart contract 506. Similarly, a match/round executor 512 can interface between middleware 510 and game state machine 518, and match/round executor 512 can serve as a coordinator or executor for different matches, rounds, and/or instances of gameplay, etc. Match/round executor 512 can further initiate rounds or game instances, and/or also record results of such rounds or game instances, in terms of victories or losses, changes in token ownership, and/or any other items of game state information or other metadata, as understood by those having skill and the art.

As first introduced above, middleware 510 can interface with an NFT indexer 502, a user wallet 504, and/or a smart contract. Accordingly, middleware 510 provides an interface between the blockchain itself, on the one hand, and the user experience implemented through front-end game 508 and one or more of the off-chain sub-components within engine runtime component 514, by referencing information or metadata within NFT indexer 502 (e.g., identifying on the actual blockchain where NFT identification/ownership information is recorded), user wallet 504 (e.g., cryptographic information used to record transactions on the blockchain itself and/or to identify corresponding blocks on the blockchain relating to a particular user account), and/or smart contract 506 (e.g., information identifying, locating, and/or describing one or more smart contracts, where the smart contract functions as a coordinator and does not necessarily implement itself changes in game state and/or in game logic, which can be recorded instead using game state machine 518). Regarding smart contract 506, this can function as the coordinator and thereby funnel information relating to game state into engine runtime 514, which can do the actual recording and tracking of changes in game state based on information received from the corresponding smart contract through chain funnel 516.

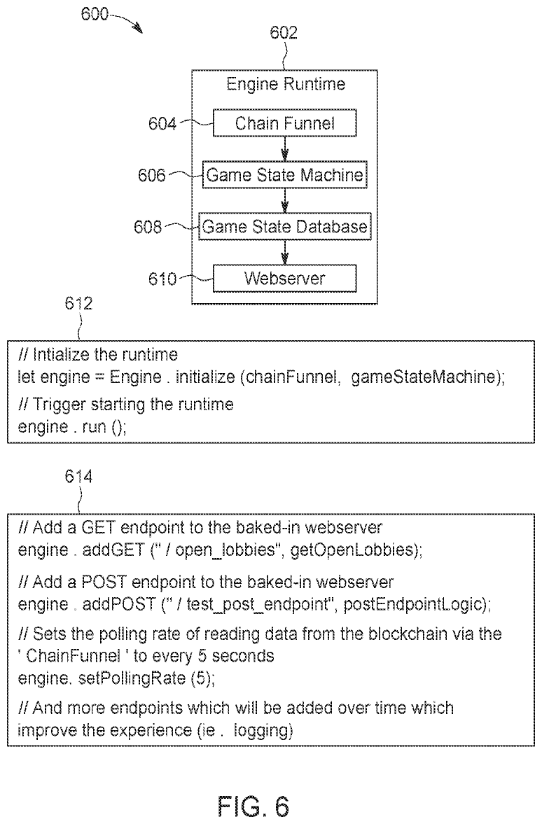

The above discussion of FIGS. 1-5 extensively describes various optional features and/or benefits of different disclosed embodiments of the technology of this application. Additionally, FIGS. 6-11 provide, in some examples, additional and further optional mechanical or implementation details regarding how one or more of these features or benefits can be programmatically created or obtained, as discussed further below. The mechanical implementation details of FIGS. 6-11 are for purposes of enablement, explanation, and illustration, and do not necessarily further limit the scope of the claims, as further outlined above, and as understood by those having skill in the art (e.g., the exact characters and formatting of computer code do not necessarily need to be followed exactly, but instead represent high-level concepts that provide enabling explanations for a representative embodiment of the various technological improvements of this application).

Beginning with FIG. 6, this figure shows a diagram 600, including an engine runtime component 602 that parallels engine runtime component 514, including a chain funnel 604, a game state machine 606, a game state database 608, and a webserver 610. In various examples, engine runtime component 602 can have one or more of the following primary jobs or tasks: reading a latest processed block height and corresponding database (e.g., game state database 608), polling chain funnel 604 at a fixed rate to acquire a new ChainData for a following block height, supplying the ChainData to a processing function of game state machine 606, and/or starting web server 610.

Diagram 600 also includes a portion 612 of computer code. Portion 612 begins with a first command that initializes engine runtime component 602. Portion 612 subsequently further includes a command to trigger starting of execution of engine runtime component 602, as further shown in this figure. Additionally, diagram 600 also includes a portion 614 of computer code. Portion 614 may correspond to an extended interface that allows customizing functionality (e.g., customizing functionality prior to using the .run( ) endpoint).

In view of the above, when a function (e.g., .run( )) is called on engine runtime component 602, one or more of the following tasks may be performed (e.g., before engine runtime component 602 begins actively working): verifying that the blockchain node provided in chainFunnel is active/accessible, verifying that the database connection info provided in game state machine 606 is valid and said database exists and/or can be connected to, and/or starting webserver 610 with one or more of the supplied GET and POST endpoints applied, as understood by those having skill in the art. If one or more of the above fails (e.g., if any of the above fails), then engine runtime component 602 can safely exit. For example, engine runtime component 602 can close webserver 610 if started, and similarly anything else actively running on a different thread can be safely closed). In these cases, engine runtime component 602 can return an error message.

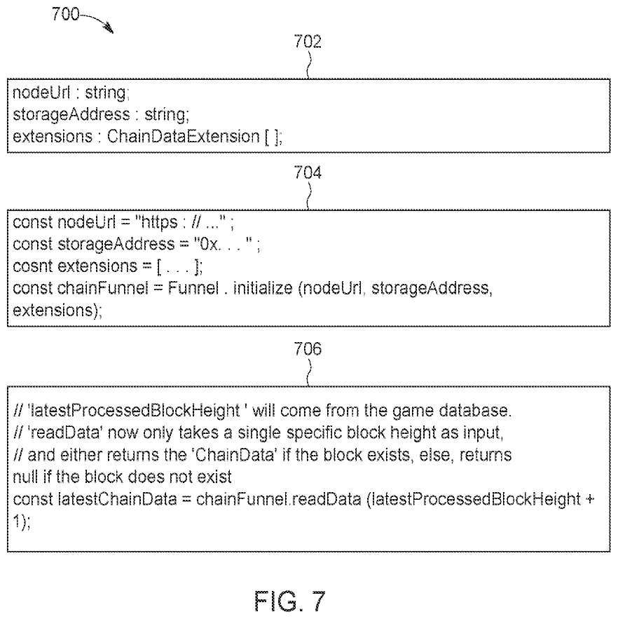

FIG. 7 shows a diagram 700 including a portion 702 of computer code, a portion 704 of computer code, and a portion 706 of computer code, which may relate to and/or implement chain funnel 604. These portions of computer code corresponding to chain funnel 604 may form at least part of the core library that enables a consumer to initialize the chain funnel object that further holds state information regarding a blockchain node (e.g., nodeURL), a deployed smart contract address (e.g., storageAddress), and/or a set of ChainDataExtensions that responding a corresponding developer has provided. Portion 702 of computer code indicates what one or more internal fields should be as part of the core library. Accordingly, portion 704 of computer code further indicates that to initialize chain funnel 604, the developer should call the functions or commands specified within portion 704 of computer code as one illustrative example. Similarly, chain funnel 604 may include a primary method that can be used to obtain ChainData (e.g., which can be akin to the readData function from related storage.ts components, but simplified as shown in FIG. 7). In view of the above, the ChainData received from chain funnel 604 can be supplied to the game state machine and thus transition the game state forward. In these examples, the readData( ) method is polled every X seconds or other unit of time, thereby providing a simple interface that will also interact well with engine runtime component 602.

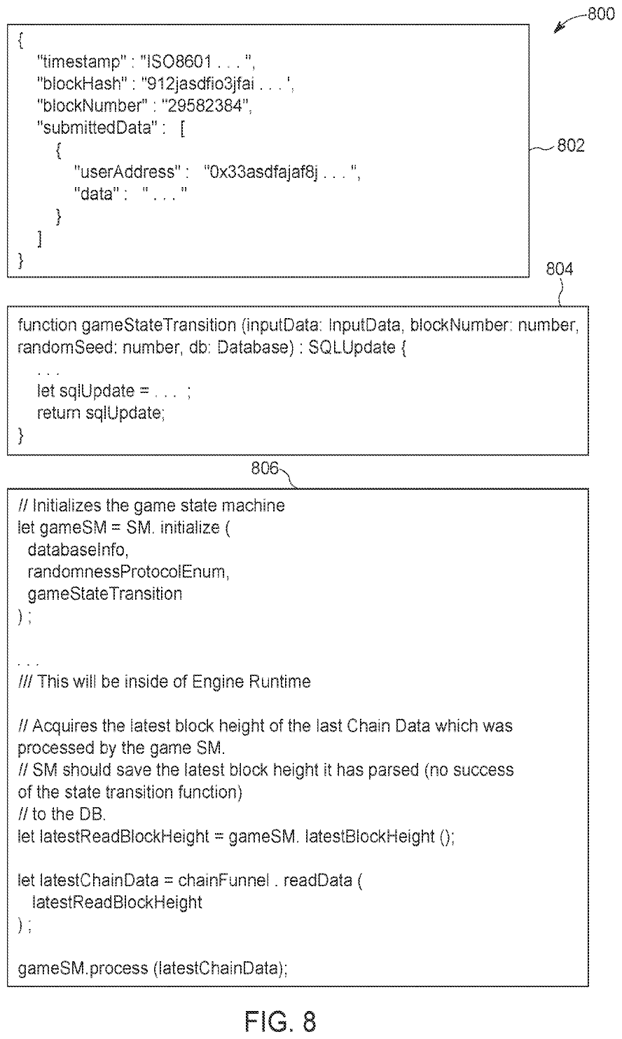

FIG. 8 shows a diagram 800 including a portion 802 of computer code, a portion 804 of computer code, and a portion 806 of computer code, which can relate to or implement game state machine 518. The state machine described herein (e.g., game state machine 518) can be written in TypeScript or TS (as shown in FIG. 8), and which can enable building state machines for a game that natively integrate with a remainder of engine architecture 500. These game state machines can effectively provide a “game loop” whereby some, all, or substantially all game logic can be held. Unlike related videogame loop technology, which can take place in a consistently timed manner (e.g., 30+ times a second), state machines corresponding to FIG. 8 might only perform state transition when a new block is produced on the blockchain that the corresponding smart contract is deployed upon. In some examples, game state machine 518 can natively integrate with a postgres database (e.g., game state database 520) as a default storage backend for global game state.

Regarding data on the blockchain, games implemented with engine architecture 500 might only perform computation by going through state transitions. As mentioned, state transitions might only take place when a new block occurs on the blockchain. Accordingly, these transitions can be funneled to game state machine 518 through chain funnel 516 by engine runtime component 514. This new chain data can be pre-processed by game state machine 518, and then fed into the corresponding games state transition function. If the blockchain block included transactions where a user submitted data to the smart contract, which can include game input, then that particular data can be processed one-by-one via the state transition function.

Portion 802 of computer code can indicate that chain data, in some examples, can be formatted according to a particular format. This particular format can optionally include, for example, a corresponding timestamp, a corresponding block hash, a corresponding block number, and a data structure that specifies submitted data, which can further include fields such as a user address corresponding to the submitted data, and the actual underlying data itself, as further illustrated in portion 802.

Regarding the state transition function to implement state transitions at game state machine 518, this state transition function can be a function where some, all, or substantially all game logic takes place. A developer using game state machine 518 can implement the developer's own particular state transition function for the various mechanics and dynamics of that developer's particular game. In some examples, the customized state transition function can take one or more of the following as input (e.g., in some cases may be required to take all of the following as input): input data, block number, randomness seed (e.g., a random seed generated by game state machine 518 to be used for randomness, and which can also optionally be saved to a database randomness table, which can optionally be included within game state database 520), and/or a database object (e.g., an object which can be used to access game state database 520 via a read-only interface). The output of said function can be a list of database update commands, which can further include all updates that will be applied to the global game state based on all of the results from the state transition since the previous state. Portion 804 of computer code (e.g., here pseudocode) can further specify an illustrative example of a state transition function, including the relevant type information).

Regarding the triggering of state transitions, before triggering such transitions, a developer may be requested or required to first initialize a game state machine object corresponding to game state machine 518. This object can connect to game state database 520 and/or can acquire the corresponding database schema. This object can also further set which randomness protocol version is to be used. Subsequently, engine runtime component 514 can acquire a next instance of ChainData (e.g., acquire from on-chain contract 506 via chain funnel 516), and then process all of the state transition for the latest block of ChainData, as further depicted within portion 806 of computer code.

The following discussion provides an overview of the internal dynamics of processing ChainData. Accordingly, the following discussion may refer to more specific example implementation details and computer code component names than the higher level block diagram of FIG. 5, but the following discussion should nevertheless be read in a manner consistent with the higher level description of engine architecture 500.

When .process(latestChainData) is called, the state machine can automatically begin performing one or more state transitions via the gameStateTransition( ) function. First the state machine checks the scheduledData table in the attached database. This can correspond to a table which stores a list of entries which have a block height (number) as their primary key, and some inputData as their value. In other words, these are scheduled actions which were generated by previous state transitions to take place at a given block height. Executing these first every time a new block is generated (even with no submitted data to the smart contract) on the chain allows for engine architecture 500 to offer passive time to games implemented with it.

In further examples, whenever .process(latestChainData) is called on the game state machine, the state machine can automatically query for all scheduled data for the current height and begin triggering gameStateTransition( ) one-by-one. After each call, the STF will return a list of SQL update queries, which the state machine can automatically apply to the database before calling the gameStateTransition( ) function again with the next input data. As such, each successive state transition has access to the latest global game state because all updates are committed to the database before proceeding (e.g., every time a piece of scheduled data is processed, it is also deleted from the scheduledData table).

Once all of the scheduled data has been processed, then the state machine begins to feed all of the submittedData from the latestChainData one-by-one to the gameStateTransition( ) function as well. Likewise, the state machine commits all SQL update queries to the database after each STF call. Note, any single given input data which was provided in submittedData may have been invalid. This means that gameStateTransition( ) may fail for that given piece of submitted data, in which case no updates are committed to the database and that submitted data is simply thrown away.

After all of the submittedData has been used one-by-one, this marks the end of processing of the ChainData. All scheduled data and all user supplied input were processed for the given block height, and thus the system has arrived at the latest state.

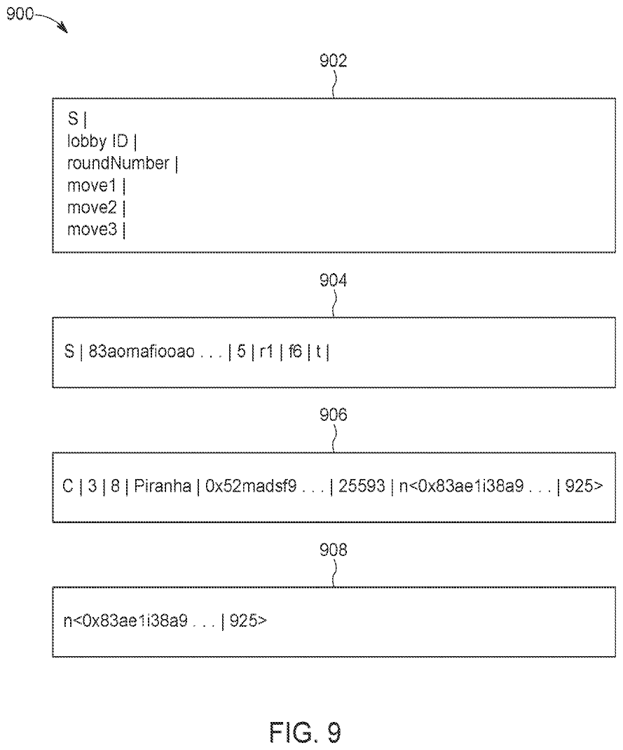

FIG. 9 shows a diagram 900 including a portion 902, a portion 904, a portion 906, and a portion 908, which can all correspond to assertions and preprocessors used with engine architecture 500. Valid concisely encoded game input when using engine architecture 500 can rely on a simple standard of using a utf-8 encoded string, for example, and which separates values by a character such as |. For example, in one representative game (e.g., named “catapult”), moves can be submitted in a match using an illustrative example of a schema shown in portion 902, where the information of portion 902 has been encoded according to utf-8 (as one illustrative example) thereby resulting in the encoded information shown within portion 904.

In view of the above, the reader can consider values inside of the |s to be the values which pertain to game state. In other words, these are values which the game state machine can validate itself and determine if they are valid and can be applied to the game state, or instead thrown away because they are invalid.

The above discussion necessarily raises a question, which is what if the user wants to submit state from the underlying blockchain into the game. The most obvious example is that the user may want to use an NFT they own inside of the game. This ownership claim/assertion is something that the game state machine cannot in and of itself verify because it does not have access to the global blockchain state.

One approach would be to use Chain Data Extensions, however this approach might only work for specific contracts. In the case of NFTs, each NFT collection has its own contract, and forcing games to ad-hoc keep tracking more and more contracts bloats out each of their game state databases further (and repeats the same state across game databases as well uselessly), and is therefore not a good path forward.

In view of the above, this application discloses in some examples a new model of assertions that address this specific use case. According to these example embodiments, a blockchain state assertion system can be created which allows users to submit assertions together with the game input.

In these example embodiments, an assertion can be a valid game input string following the previous | based standard, however with the new assertion syntax added thereupon. Portion 906 shows an illustrative example of what creating a lobby in a particular representative game (e.g., “catapult”) might look like regarding an NFT ownership assertion.

As can be seen, in these illustrative examples, assertions can use a X<input|input|input|. . . > syntax, where the prefix X is one or more lowercase letters which specify the assertion (and thus also specify how many inputs are expected). An assertion makes a claim about the underlying blockchain state which must be true in order for the game input to be considered valid. Thus if a single one of the assertions in a game input string fails to validate at the current block height, then the game input can be thrown away before it is even fed to the game state machine.

In addition to the above, the following remarks and potential recommendations regarding assertions, in the context of various examples, can be helpful. For example, assertions should be included at the very back of the game input string. In further examples, game input can still be invalid even if all assertions in the game input are valid. In additional examples, each game can be required to specify the maximum number of assertions it supports in a single game input, and this ideally should never change to prevent history forking. In further examples, invalid assertions with either too many inputs, invalid inputs, or with an unsupported prefix are thrown away.

Regarding preprocessors, in some examples every game input submitted goes through one or more preprocessors if it has assertions inside of it. The preprocessor (attached to an indexer of blockchain state) then either returns a true or false defining whether or not the assertion(s) inside of the game input is valid. In these examples, if any of the preprocessors return false, then the assertion is invalid, and thus the whole game input is invalid and thrown away (thus it never is fed into the game state machine).

In further examples, when initializing chain funnel 516 for a specific game the consumer may be requested to, or required to, also specify the maximum number of assertions that are allowed to be a part of the input data. This allows chain funnel 516 to filter input data which has too many assertions, and prevents attacks where bad actors may try to perform a denial of service attack with too many assertions.

As one illustrative example of such an assertion that has preprocessors implemented, the reader can consider the example of NFT (ERC 721) ownership assertion. This assertion makes the claim that the user who submitted the game input has ownership of the given NFT at the block height it was submitted. In this representative example, the assertion has a n prefix, and two input values. The first input value is the ERC721 contract address, and the second value is the id of the NFT that the user is claiming to own. These details are shown in portion 908 of diagram 900. Of course, this particular NFT protocol (ERC 721) and the particular configuration for this assertion are merely representative for illustration purposes, and in other examples different or other protocols and configurations can be used, as understood by those having skill in the art.

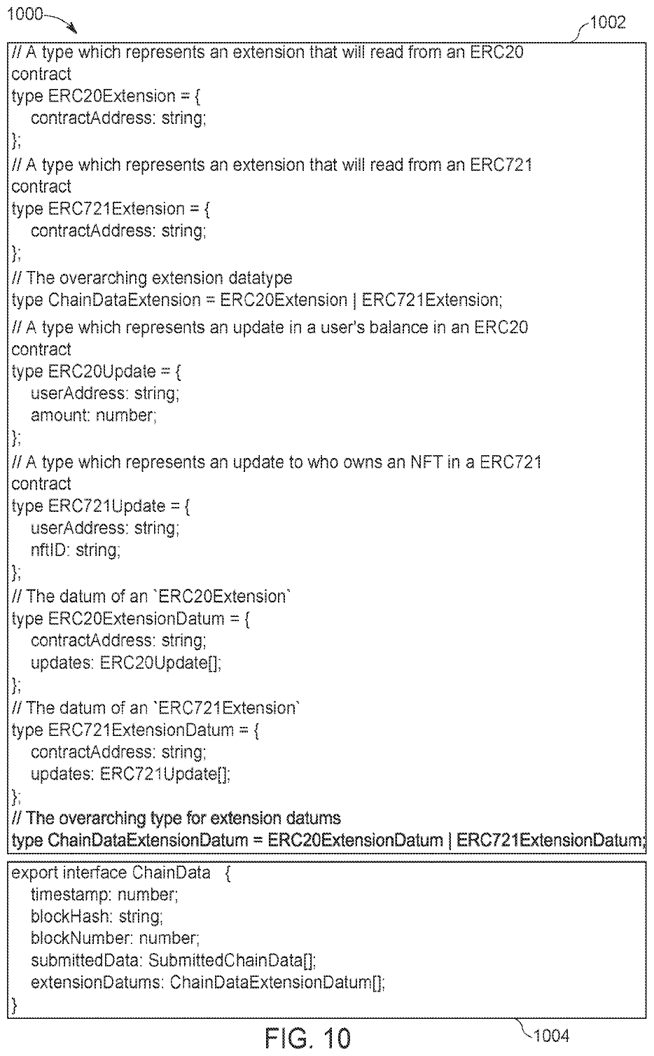

FIG. 10 shows a diagram 1000 including a portion 1002 of computer code and a portion 1004 of computer code, which can relate to chain data extensions. In some examples, it can be desirable to provide games which are reliant off of additional on-chain state, as discussed further below. In related examples, the only on-chain state that is available for a game state machine to consume is the set of submitted data by users to the deployed smart contract for that particular game. All other on-chain state is not necessarily passed to the state machine in order to keep the model efficient and prevent database bloat and added complexity. Although this may be sufficient for these related examples, in other examples this can be improved upon such that the chain data which is fed to the game state machine is extended with whatever on-chain state the game happens to require or involve. For example, a developer may wish to pull into engine architecture 500 the state of the particular NFT contract (e.g., ERC-721 contract), so that users are allowed to perform an arbitrary piece of functionality in-game if the state indicates that they provably own that particular NFT.

The example improvements outlined above will effectively create a flow between storage of engine architecture 500 and the state machine, which further allows the developer of the game state machine to specify which chain data extensions the developer wishes to use and automatically have access to that particular data in a corresponding database (e.g., in a hands-free manner). The following discussion further provides, at a high level of generality for illustrative purposes, a roadmap for implementation details for how to accomplish these improvements.

More specifically, in some examples, these improvements may be implemented in part through ChainDataExtensions. In these examples, each ChainDataExtension will have a corresponding ChainDataExtensionDatum type which will hold the data for a given instantiation of an extension. In other words, a ChainDataExtension specifies what new data will be funneling from on-chain, and ChainDataExtensionDatum is the actual new data from the chain in the given block. Portion 1002 shows illustrative examples of such chain data extensions, including a type which represents an extension that will read from an ERC20 contract, a type which represents an extension that will read from an ERC721 contract, an overarching extension datatype, a type which represents an update in a user's balance in an ERC20 contract, and a type which represents an update to who owns an NFT in an ERC721 contract, an example datum of ERC20Extension, an example datum of an ERC721Extension, and an overarching type for extension datums. As further indicated by portion 1002, the separation between the extension and the extension datum at the type level enables easier integration of these features with engine architecture 500. In view of the above, portion 1004 further illustrates how, due to these exceptions, ChainData can now contain a new field which holds all of the extension datums.

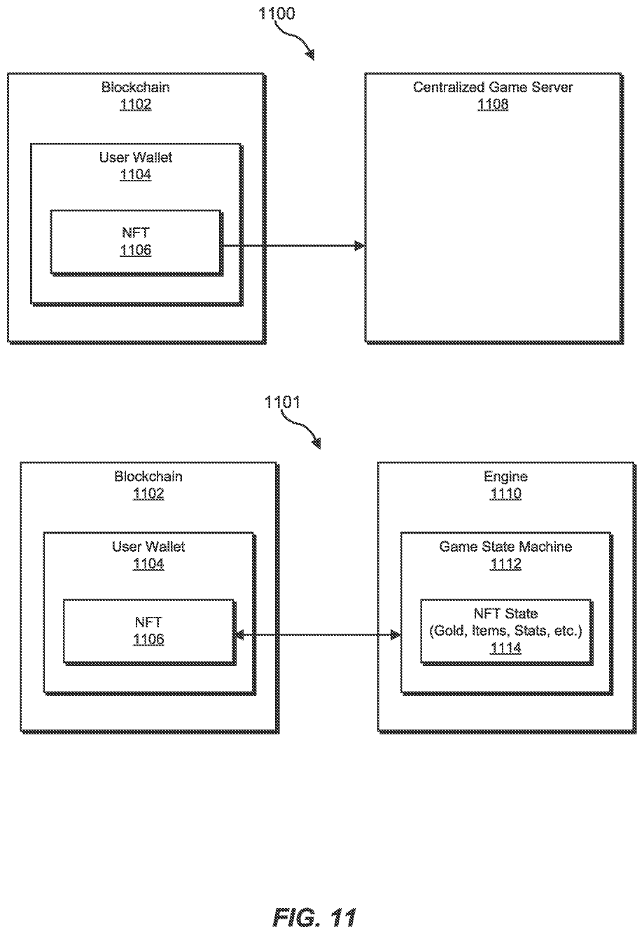

For completeness, FIG. 11 also provides a diagram 1100 and a diagram 1101 that help illustrate the differences between classical static NFTs (corresponding to diagram 1100) and stateful NFTs (corresponding to diagram 1101 and FIG. 3). As further shown in this figure, related blockchain gaming applications and configurations may include a blockchain 1102 that further includes a user wallet 1104 which contains an NFT 1106 (e.g., a static or classical NFT). In this case, a centralized game server 1108 simply interacts with NFT 1106 over a one-way anchor relationship, according to which ownership status of NFT 1106 is provided and verified to centralized game server 1108.

In contrast, according to diagram 1101, blockchain 1102 can still include user wallet 1104 containing NFT 1106, and yet engine 1110 (corresponding to engine architecture 500) can further include game state machine 1114 (corresponding to game state machine 518) that tracks and records dynamic changes in state information corresponding to the same NFT 1106. In contrast to the one-way anchor of diagram 1100, diagram 1101 features a two-way data anchor whereby the game state machine can indicate or record ownership within blockchain 1102 in one direction, and the NFT game state can be recorded within game state machine 1112 from blockchain 1102, in the opposite direction, as further illustrated in this figure. Additionally, NFT state 1114 can further track changes in state information such as a number, attribute, or other metadata instance regarding in-game gold, items, statistics, etc., as understood by those having skill in the art.

In addition to the above discussion of FIGS. 1-11, the following provides an additional discussion of implementation details regarding randomness generation which can be incorporated in various examples of engine architecture 500, as discussed in more detail below. Randomness is used in certain games and having a good source of randomness prevents users from abusing statistical trends to their own benefit.

In some examples of engine architecture 500, the engine is configured to produce games as globally accessible state machines. In other words, these games can be inherently deterministic (i.e., because everyone has to replay all submitted game input to arrive at the same global state). Furthermore, in these examples, there can be no central server relied upon which could be trusted to produce randomness (i.e., as a randomness oracle). In view of these configuration details for these environments, the advantages of having a good source of randomness can increase.

In view of the above, various examples of engine architecture 500 can be configured such that, whenever a new block is generated there are two pieces of information provided to the engine architecture where these two pieces of information have a degree of uncertainty or randomness to them which makes them harder to predict: the block hash and the list of submitted data (user game input) which was posted by users to the on-chain smart contract. As such, these are pieces of data on which randomness can be further built.

In a first example, a randomness generation protocol can simply use the block hash. In this example, the block hash can be sufficient for simple games, and yet may not be as advantageous for increasingly complex games. Accordingly, in a second example the hash of all of the data submitted to the on-chain smart contract in the latest block can be combined with the block hash. Because this is user generated or submitted data, this can have much more randomness due to the fact that there can be a potentially significantly larger number of actors submitting input.

In additional examples, an automated piece of software can be set up which submits data to the smart contract in order to improve the randomness of the second example just listed above. Nevertheless, one suboptimization of the second example, perhaps arising in certain scenarios, is that the block producer can still have the power to decide on which transactions to include in the block, and therefore the producer can collude and censor all transactions to the smart contract. In these scenarios, the block producer can then work on finding a block hash that benefits the producer (although this can seem unlikely for a block producer to collude in the context of a videogame, it is nevertheless theoretically possible and can be addressed by the technological improvements described herein and further below).

In view of the above, in a third example, it can be a goal to improve randomness generation such that it becomes significantly harder for the block producer to collude. This can be achieved by leveraging an iteratively generated source of randomness. In other words, rather than just using the data from the latest block, the previously generated randomness from the last 10 blocks (as one threshold number) can be cached and then combined together.

In a fourth example, the randomness of the latest 25 blocks (as another example threshold number) can be cached, and then this resulting cache can be used with the protocol of the second example to generate a temporal-randomness, which is then further used to select which of the previous latest 25 blocks randomness should be chosen to combine with the temporal-randomness to generate a final randomness seed.

Returning to the first example, the submitted data from the last 25 blocks can be cached, and by using the randomness of the latest block from the second example, start from block X-25 and randomly select which submitted data to use as a part of generating a new source of randomness. Once a random set of submittedData is selected from block X-25, then the protocol moves to X-24 using the newly generated randomness to select a subset of the submitted data from the block, and so on. In other words, the idea behind the description above is that with the computation of generating the randomness can be quite complex such that it becomes nearly impossible for a block producer to manipulate the process for the producer's own benefit within the timeframe that they have to produce a block (e.g., by trying to find or create a block with a specific set of submitted data by users and a specific block hash that benefits the producer).

FIG. 12 is a block diagram of an example computing system 1210 capable of implementing one or more of the embodiments described and/or illustrated herein. For example, all or a portion of computing system 1210 may perform and/or be a means for performing, either alone or in combination with other elements, one or more of the steps described herein (such as one or more of the steps illustrated in FIG. 3). All or a portion of computing system 1210 may also perform and/or be a means for performing any other steps, methods, or processes described and/or illustrated herein.

Computing system 1210 broadly represents any single or multi-processor computing device or system capable of executing computer-readable instructions. Examples of computing system 1210 include, without limitation, workstations, laptops, client-side terminals, servers, distributed computing systems, handheld devices, or any other computing system or device. In its most basic configuration, computing system 1210 may include at least one processor 1214 and a system memory 1216.

Processor 1214 generally represents any type or form of physical processing unit (e.g., a hardware-implemented central processing unit) capable of processing data or interpreting and executing instructions. In certain embodiments, processor 1214 may receive instructions from a software application or module. These instructions may cause processor 1214 to perform the functions of one or more of the example embodiments described and/or illustrated herein.

System memory 1216 generally represents any type or form of volatile or non-volatile storage device or medium capable of storing data and/or other computer-readable instructions. Examples of system memory 1216 include, without limitation, Random Access Memory (RAM), Read Only Memory (ROM), flash memory, or any other suitable memory device. Although not required, in certain embodiments computing system 1210 may include both a volatile memory unit (such as, for example, system memory 1216) and a non-volatile storage device (such as, for example, primary storage device 1232, as described in detail below). In one example, one or more of modules 102 from FIG. 1 may be loaded into system memory 1216.

In some examples, system memory 1216 may store and/or load an operating system 1240 for execution by processor 1214. In one example, operating system 1240 may include and/or represent software that manages computer hardware and software resources and/or provides common services to computer programs and/or applications on computing system 1210. Examples of operating system 1240 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 1210 may also include one or more components or elements in addition to processor 1214 and system memory 1216. For example, as illustrated in FIG. 12, computing system 1210 may include a memory controller 1218, an Input/Output (I/O) controller 1220, and a communication interface 1222, each of which may be interconnected via a communication infrastructure 1212. Communication infrastructure 1212 generally represents any type or form of infrastructure capable of facilitating communication between one or more components of a computing device. Examples of communication infrastructure 1212 include, without limitation, a communication bus (such as an Industry Standard Architecture (ISA), Peripheral Component Interconnect (PCI), PCI Express (PCIe), or similar bus) and a network.

Memory controller 1218 generally represents any type or form of device capable of handling memory or data or controlling communication between one or more components of computing system 1210. For example, in certain embodiments memory controller 1218 may control communication between processor 1214, system memory 1216, and I/O controller 1220 via communication infrastructure 1212.

I/O controller 1220 generally represents any type or form of module capable of coordinating and/or controlling the input and output functions of a computing device. For example, in certain embodiments I/O controller 1220 may control or facilitate transfer of data between one or more elements of computing system 1210, such as processor 1214, system memory 1216, communication interface 1222, display adapter 1226, input interface 1230, and storage interface 1234.

As illustrated in FIG. 12, computing system 1210 may also include at least one display device 1224 coupled to I/O controller 1220 via a display adapter 1226. Display device 1224 generally represents any type or form of device capable of visually displaying information forwarded by display adapter 1226. Similarly, display adapter 1226 generally represents any type or form of device configured to forward graphics, text, and other data from communication infrastructure 1212 (or from a frame buffer, as known in the art) for display on display device 1224.

As illustrated in FIG. 12, example computing system 1210 may also include at least one input device 1228 coupled to I/O controller 1220 via an input interface 1230. Input device 1228 generally represents any type or form of input device capable of providing input, either computer or human generated, to example computing system 1210. Examples of input device 1228 include, without limitation, a keyboard, a pointing device, a speech recognition device, variations or combinations of one or more of the same, and/or any other input device.

Additionally or alternatively, example computing system 1210 may include additional I/O devices. For example, example computing system 1210 may include I/O device 1236. In this example, I/O device 1236 may include and/or represent a user interface that facilitates human interaction with computing system 1210. Examples of I/O device 1236 include, without limitation, a computer mouse, a keyboard, a monitor, a printer, a modem, a camera, a scanner, a microphone, a touchscreen device, variations or combinations of one or more of the same, and/or any other I/O device.

Communication interface 1222 broadly represents any type or form of communication device or adapter capable of facilitating communication between example computing system 1210 and one or more additional devices. For example, in certain embodiments communication interface 1222 may facilitate communication between computing system 1210 and a private or public network including additional computing systems. Examples of communication interface 1222 include, without limitation, a wired network interface (such as a network interface card), a wireless network interface (such as a wireless network interface card), a modem, and any other suitable interface. In at least one embodiment, communication interface 1222 may provide a direct connection to a remote server via a direct link to a network, such as the Internet. Communication interface 1222 may also indirectly provide such a connection through, for example, a local area network (such as an Ethernet network), a personal area network, a telephone or cable network, a cellular telephone connection, a satellite data connection, or any other suitable connection.

In certain embodiments, communication interface 1222 may also represent a host adapter configured to facilitate communication between computing system 1210 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 1222 may also allow computing system 1210 to engage in distributed or remote computing. For example, communication interface 1222 may receive instructions from a remote device or send instructions to a remote device for execution.

In some examples, system memory 1216 may store and/or load a network communication program 1238 for execution by processor 1214. In one example, network communication program 1238 may include and/or represent software that enables computing system 1210 to establish a network connection 1242 with another computing system (not illustrated in FIG. 12) and/or communicate with the other computing system by way of communication interface 1222. In this example, network communication program 1238 may direct the flow of outgoing traffic that is sent to the other computing system via network connection 1242. Additionally or alternatively, network communication program 1238 may direct the processing of incoming traffic that is received from the other computing system via network connection 1242 in connection with processor 1214.

Although not illustrated in this way in FIG. 12, network communication program 1238 may alternatively be stored and/or loaded in communication interface 1222. For example, network communication program 1238 may include and/or represent at least a portion of software and/or firmware that is executed by a processor and/or Application Specific Integrated Circuit (ASIC) incorporated in communication interface 1222.

As illustrated in FIG. 12, example computing system 1210 may also include a primary storage device 1232 and a backup storage device 1233 coupled to communication infrastructure 1212 via a storage interface 1234. Storage devices 1232 and 1233 generally represent any type or form of storage device or medium capable of storing data and/or other computer-readable instructions. For example, storage devices 1232 and 1233 may be a magnetic disk drive (e.g., a so-called hard drive), a solid state drive, a floppy disk drive, a magnetic tape drive, an optical disk drive, a flash drive, or the like. Storage interface 1234 generally represents any type or form of interface or device for transferring data between storage devices 1232 and 1233 and other components of computing system 1210.

In certain embodiments, storage devices 1232 and 1233 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 1232 and 1233 may also include other similar structures or devices for allowing computer software, data, or other computer-readable instructions to be loaded into computing system 1210. For example, storage devices 1232 and 1233 may be configured to read and write software, data, or other computer-readable information. Storage devices 1232 and 1233 may also be a part of computing system 1210 or may be a separate device accessed through other interface systems.

Many other devices or subsystems may be connected to computing system 1210. Conversely, all of the components and devices illustrated in FIG. 12 need not be present to practice the embodiments described and/or illustrated herein. The devices and subsystems referenced above may also be interconnected in different ways from that shown in FIG. 12. Computing system 1210 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 1210. All or a portion of the computer program stored on the computer-readable medium may then be stored in system memory 1216 and/or various portions of storage devices 1232 and 1233. When executed by processor 1214, a computer program loaded into computing system 1210 may cause processor 1214 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 1210 may be configured as an Application Specific Integrated Circuit (ASIC) adapted to implement one or more of the example embodiments disclosed herein.

FIG. 13 is a block diagram of an example network architecture 1300 in which client systems 1310, 1320, and 1330 and servers 1340 and 1345 may be coupled to a network 1350. As detailed above, all or a portion of network architecture 1300 may perform and/or be a means for performing, either alone or in combination with other elements, one or more of the steps disclosed herein (such as one or more of the steps illustrated in FIG. 3). All or a portion of network architecture 1300 may also be used to perform and/or be a means for performing other steps and features set forth in the present disclosure.

Client systems 1310, 1320, and 1330 generally represent any type or form of computing device or system, such as example computing system 1210 in FIG. 12. Similarly, servers 1340 and 1345 generally represent computing devices or systems, such as application servers or database servers, configured to provide various database services and/or run certain software applications. Network 1350 generally represents any telecommunication or computer network including, for example, an intranet, a WAN, a LAN, a PAN, or the Internet. In one example, client systems 1310, 1320, and/or 1330 and/or servers 1340 and/or 1345 may include all or a portion of system 100 from FIG. 1.

As illustrated in FIG. 13, one or more storage devices 1360(1)-(N) may be directly attached to server 1340. Similarly, one or more storage devices 1370(1)-(N) may be directly attached to server 1345. Storage devices 1360(1)-(N) and storage devices 1370(1)-(N) generally represent any type or form of storage device or medium capable of storing data and/or other computer-readable instructions. In certain embodiments, storage devices 1360(1)-(N) and storage devices 1370(1)-(N) may represent Network-Attached Storage (NAS) devices configured to communicate with servers 1340 and 1345 using various protocols, such as Network File System (NFS), Server Message Block (SMB), or Common Internet File System (CIFS).

Servers 1340 and 1345 may also be connected to a Storage Area Network (SAN) fabric 1380. SAN fabric 1380 generally represents any type or form of computer network or architecture capable of facilitating communication between a plurality of storage devices. SAN fabric 1380 may facilitate communication between servers 1340 and 1345 and a plurality of storage devices 1390(1)-(N) and/or an intelligent storage array 1395. SAN fabric 1380 may also facilitate, via network 1350 and servers 1340 and 1345, communication between client systems 1310, 1320, and 1330 and storage devices 1390(1)-(N) and/or intelligent storage array 1395 in such a manner that devices 1390(1)-(N) and array 1395 appear as locally attached devices to client systems 1310, 1320, and 1330. As with storage devices 1360(1)-(N) and storage devices 1370(1)-(N), storage devices 1390(1)-(N) and intelligent storage array 1395 generally represent any type or form of storage device or medium capable of storing data and/or other computer-readable instructions.

In certain embodiments, and with reference to example computing system 1210 of FIG. 12, a communication interface, such as communication interface 1222 in FIG. 12, may be used to provide connectivity between each client system 1310, 1320, and 1330 and network 1350. Client systems 1310, 1320, and 1330 may be able to access information on server 1340 or 1345 using, for example, a web browser or other client software. Such software may allow client systems 1310, 1320, and 1330 to access data hosted by server 1340, server 1345, storage devices 1360(1)-(N), storage devices 1370(1)-(N), storage devices 1390(1)-(N), or intelligent storage array 1395. Although FIG. 13 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 1340, server 1345, storage devices 1360(1)-(N), storage devices 1370(1)-(N), storage devices 1390(1)-(N), intelligent storage array 1395, or any combination thereof. All or a portion of one or more of the example embodiments disclosed herein may also be encoded as a computer program, stored in server 1340, run by server 1345, and distributed to client systems 1310, 1320, and 1330 over network 1350.

As detailed above, computing system 1210 and/or one or more components of network architecture 1300 may perform and/or be a means for performing, either alone or in combination with other elements, one or more steps of an example method for facilitating blockchain applications.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 100 in FIG. 1 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 100 in FIG. 1 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 100 in FIG. 1 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smart watches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 100 in FIG. 1 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 100 in FIG. 1 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 100 in FIG. 1 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for facilitating blockchain applications, at least a portion of the method being performed by a computing device comprising at least one processor, the method comprising:
providing access to a scalability engine for at least one application that is implemented on a blockchain; and
facilitating execution of the application using the scalability engine;
wherein:
the scalability engine uses a smart contract on-chain that acts as a coordinator with an off-chain state machine that computes a state of the application.

2. The computer-implemented method of claim 1, wherein the application comprises a blockchain gaming application.

3. The computer-implemented method of claim 2, wherein the off-chain state machine computes a state of the blockchain gaming application.

4. The computer-implemented method of claim 2, wherein the scalability engine enables a user with access to the blockchain to read on-chain data that verifies a latest state of the blockchain gaming application in a zero trust configuration.

5. The computer-implemented method of claim 2, wherein the blockchain preserves substantially all data for operation of the blockchain gaming application.

6. The computer-implemented method of claim 2, wherein the blockchain gaming application implements passive time such that the blockchain gaming application advances while bypassing a requirement for a user to submit a new transaction to the blockchain.

7. The computer-implemented method of claim 1, wherein the state machine operates as an L2 chain.

8. The computer-implemented method of claim 1, wherein the scalability engine computes gas usage based on a calculation in terms of a user address, a game input, and a digital signature of the game input.

9. The computer-implemented method of claim 1, wherein the scalability engine renders gas usage and transaction fees strictly dependent on a number of bytes that a user submits for their input to the application.

10. The computer-implemented method of claim 1, wherein the scalability engine enables true blockchain player-versus-environment gaming.

11. A non-transitory computer-readable medium storing instructions that, when executed by a physical processor of a computing device, cause the computing device to perform a method comprising:
providing access to a scalability engine for at least one application that is implemented on a blockchain; and
facilitating execution of the application using the scalability engine;
wherein:
the scalability engine uses a smart contract on-chain that acts as a coordinator with an off-chain state machine that computes a state of the application.

12. The non-transitory computer-readable medium of claim 11, wherein the application comprises a blockchain gaming application.

13. The non-transitory computer-readable medium of claim 12, wherein the off-chain state machine computes a state of the blockchain gaming application.

14. The non-transitory computer-readable medium of claim 12, wherein the scalability engine enables a user with access to the blockchain to read on-chain data that verifies a latest state of the blockchain gaming application in a zero trust configuration.

15. The non-transitory computer-readable medium of claim 12, wherein the blockchain preserves substantially all data for operation of the blockchain gaming application.

16. The non-transitory computer-readable medium of claim 12, wherein the blockchain gaming application implements passive time such that the blockchain gaming application advances while bypassing a requirement for a user to submit a new transaction to the blockchain.

17. The non-transitory computer-readable medium of claim 11, wherein the state machine operates as an L2 chain.

18. The non-transitory computer-readable medium of claim 11, wherein the scalability engine computes gas usage based on a calculation in terms of a user address, a game input, and a digital signature of the game input.

19. The non-transitory computer-readable medium of claim 11, wherein the scalability engine renders gas usage and transaction fees strictly dependent on a number of bytes that a user submits for their input to the application.

20. A system comprising:
a providing module, stored in memory, that provides access to a scalability engine for at least one application that is implemented on a blockchain;
a facilitating module, stored in memory, that facilitates execution of the application using the scalability engine; and
at least one physical processor configured to execute the providing module and the facilitating module;
wherein:
the scalability engine uses a smart contract on-chain that acts as a coordinator with an off-chain state machine that computes a state of the application.
